(19) United States
(12) Patent Application Publication
(10) Pub. No.: US 2008/0292177 A1
(43) Pub. Date: Nov. 27, 2008

(54) System and Method for Providing Backside Alignment in a Lithographic Projection System

(76) Inventors: Ronald E. Sheets, Santa Ana, CA (US); John R. Bjorkman, Costa Mesa, CA (US)

Correspondence Address: Jennifer H. Hamilton;THE ECLIPSE GROUP LLP, Suite 300, 10605 Balboa Blvd., Granada Hills, CA, 91344, US

(21) Appl. No.: 11/752,744

(22) Filed: May 23, 2007

(51) Int. Cl. G06K 9/00; G01B 11/00; G06K 9/28

(52) U.S. Cl. 382/151; 356/400; 382/324

(57) ABSTRACT

A system and method of providing alignment of the top surface of the substrate to alignment marks on the back side of the substrate on a lithographic projection system. A back-side optical alignment system is integrated under a movable substrate stage of the projection system. Alignment marks on the mask, which correspond to the location and separation of the substrate back side alignment marks are projected directly using UV illumination to the back-side optical alignment system, processed by a pattern recognition optical system, and stored. With a substrate on the movable stage, the substrate back-side alignment marks are positioned to correspond with the stored co-ordinate data. The projection system images the front side of the wafer after it has been aligned to the back side alignment marks.

### BACKGROUND OF THE INVENTION

1. Field of the Invention

The present invention relates to projection lithographic systems, and more particularly to systems and methods for providing substrate alignment in projection lithographic systems.

2. Description of Related Art

In the manufacture of micro-electro mechanical systems (MEMS), MEMS components are fabricated on both sides of the substrate. The components on each side of the substrate are defined by patterns, one pattern for the top side of the substrate and one pattern for the back side of the substrate. During manufacture, the pattern on the top side of the substrate is aligned to the pattern on the back side of the substrate. It is desired that this alignment be performed as accurately as possible.

In early MEMS systems, contact printers were used and two masks were employed to provide simultaneous exposure of both sides of the wafer. Such systems included optical split-field microscopes positioned under a bottom mask chuck to allow viewing of two alignment marks on the back side of the wafer and corresponding alignment marks on the bottom mask. Alignment of the wafer was accomplished by a pick and place mechanism which moved the wafer in close proximity to the bottom mask until the alignment marks were superimposed. Then the wafer was pressed down against the mask, in effect displacing the air to achieve a pseudo-vacuum clamping of the wafer to the bottom mask. Next the top mask was positioned in close proximity to the top of the wafer and aligned to the wafer again using a second split field microscope. During this operation, the top mask would be moved along an X-Y plane (parallel with the wafer plane), and about a ‘Theta’ axis (perpendicular to the wafer) to achieve alignment with the top of the wafer.

This method has a number of problems in that the wafer was not constrained and could be inadvertently moved if the top mask touched the wafer. Further if the wafer was slightly warped, it would not be possible to squeeze the air out in order to get pseudo-vacuum clamping of the wafer to the bottom mask.

Projection printing offered an alternative to contact printing, and included methods that utilize optical elements embedded into the substrate (wafer) stage. These optical elements consist of mirrors, lenses or prisms to allow the back side of the substrate alignment marks to be relayed for viewing from a position adjacent to the edge of the substrate. These systems require some reference position on the stage to which the back side alignment marks are referenced.

Other methods have been developed that include using long wavelength infra-red radiation which can be viewed through a silicon substrate using suitable optical elements able to transmit infra-red radiation. However, many substrates used in semiconductor fabrication employ several thin film metal layers that are opaque to IR radiation. Thus, use of IR radiation works for only certain selected processes, which do not employ thin films of metal.

Other alignment systems include using etching alignment marks through a thinned wafer. These alignment marks are reactive ion etched approximately 10 um deep in two locations on the back side of the wafer. The wafer is then bonded to a suitable carrier and thinned to a 10 um thickness making the alignment mark on the back side clearly visible from the front side. Once the alignment mark is visible, subsequent imaging of the circuitry on the front side may be aligned to the back side pattern.

In projection systems that utilize heavy refracting or catadioptic projection lenses, it is not possible to focus the projected image on the top surface of the substrate by moving the projection lens. Focusing on the top surface is normally done by moving the wafer up and down along the optical axis of the projection lens. For cases where the substrate thickness can vary from several microns to a few millimeters, it is inconvenient to refocus on the transferred image of the back side alignment marks using through-the-lens alignment. In order to accomplish alignment, a movable off-axis alignment system is utilized with the ability to change focal position to match the relayed image from the fore-mentioned mirror-lens or prism type systems. Further any fixed optical system that is integrated into the substrate stage must be correctly positioned under the back side alignment marks within the range of capture of the system. This condition compromises the magnification of the system and effectively reduces the alignment accuracy.

There is a need for improved systems and methods for providing alignment of a pattern on the top side of a substrate with a pattern on the back side of the substrate.

### SUMMARY

In view of the above, systems and methods are provided for aligning a pattern mask to a back-side of a substrate. In an example method for aligning a top-side pattern mask with a substrate back-side, an image is captured of a mask alignment mark in an image field of view using a movable back-side alignment camera system. The back-side alignment camera system is fixed to a reference position corresponding to the location of the image of the mask alignment mark in the image field of view. An image of a substrate alignment mark is captured on the substrate back-side using the fixed position back-side alignment camera system. The substrate is positioned to align the image of the substrate alignment mark with the image of the mask alignment mark.

In an example system for aligning a pattern mask to a substrate back-side, a pattern mask having at least one mask alignment mark is mounted on a mask stage. A substrate stage is provided for mounting a substrate having at least one substrate alignment mark on the substrate back-side. The substrate stage is positioned substantially parallel to the mask stage and movable along a plane parallel to the mask stage. The substrate stage and mask stage are also connected and movable as a unit. The example system also includes a back-side alignment camera system positioned beneath the substrate stage. The back-side alignment camera system includes an objective lens aligned with an optical path to a camera, which in some examples is a CCD camera. The back-side alignment camera system is movable along a plane parallel to the substrate stage and operable to capture an image of the mask alignment mark. The image is analyzed to identify a reference position. The back-side alignment camera system is locked in at the reference position to capture a substrate back-side image for aligning the substrate back-side image with the image of the mask alignment mark.

Various advantages, aspects and novel features of the present invention, as well as details of an illustrated embodiment thereof, will be more fully understood from the following description and drawings.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a schematic diagram of an example of a projection lithographic system in which example systems and methods for providing back-side pattern alignment with a top-side pattern on a substrate may be implemented.

FIG. 2A is a flowchart of an example of a first part of a method for providing alignment of a top-side pattern mask to a back-side surface of a substrate that may be implemented in the projection lithographic system of FIG. 1.

FIG. 2B is a flowchart of an example of a second part of a method for providing alignment of a top-side pattern mask to a back-side surface of a substrate that may be implemented in the projection lithographic system of FIG. 1.

FIG. 2C is a schematic diagram illustrating operation of the method described with reference to FIG. 2A.

FIG. 2D is a schematic diagram illustrating operation of the method described with reference to FIG. 2B.

FIG. 2E is a schematic diagram illustrating one example for determining a ΔXY offset between the mask alignment mark image and the substrate alignment mark image.

FIG. 3 is an example of a back side alignment camera assembly that may be used in the system shown in FIG. 1.

FIG. 4 is a schematic diagram of a back-side camera X-Y alignment stages assembly that may be used in the example shown in FIG. 1 to control the movement of a backside camera system in the X-Y plane.

FIG. 5 is an example of a projection lithographic system 500 for providing alignment further illustrating functions for performing backside substrate X-Y, theta alignment.

### DETAILED DESCRIPTION

In the following description of preferred embodiments, reference is made to the accompanying drawings that form a part hereof, and which show, by way of illustration, specific embodiments in which the invention may be practiced. Other embodiments may be utilized and structural changes may be made without departing from the scope of the present invention.

### 1. Example Projection Lithographic System Using an Example of a System for Providing Backside Alignment

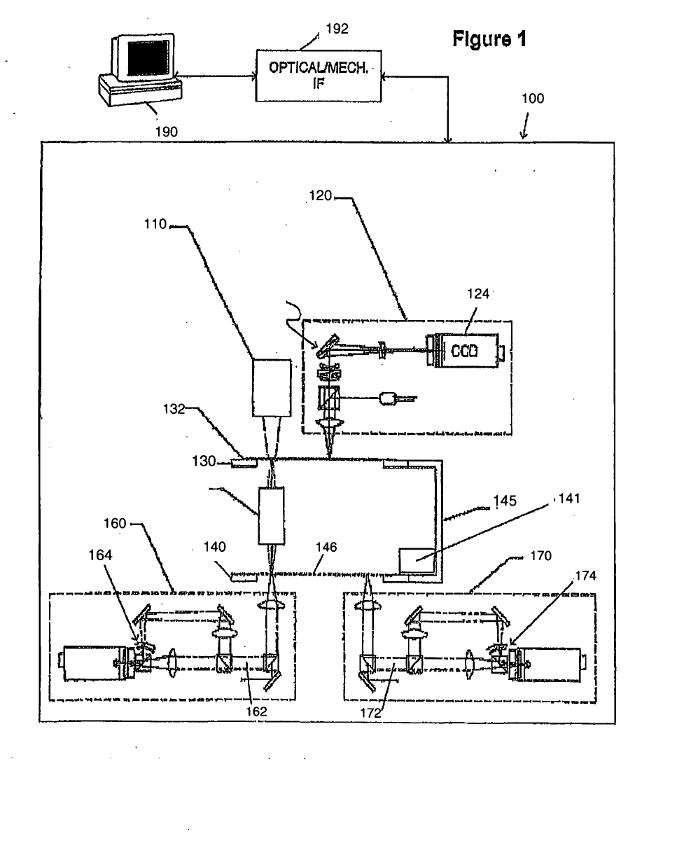

FIG. 1 is a schematic diagram of an example of a projection lithographic system 100 in which example systems and methods for providing top-side pattern alignment with a back-side pattern on a substrate. The projection lithographic system 100 includes a ultra-violet light (“UV”) exposure illuminator 110, a top-side alignment camera system 120, a mask stage 130, a substrate stage 140, a UV exposure projection lens 150, a first back-side dual magnification alignment camera system 160, and a second back-side dual magnification alignment camera system 170. The projection lithographic system 100 is connected to a controller 190 via an optical/mechanical hardware interface 192. The projection lithographic system 100 in FIG. 1 may be used to image and expose a precise pattern on the top of a substrate (not shown) aligned with an existing pattern on the bottom (back side) of the substrate.

The projection lithographic system 100 may be a full-field scanning, a step and repeat system or any other type of projection lithographic system 100 that may make advantageous use of systems and methods for top-side pattern alignment with a back-side pattern. The precise top-side pattern is provided on a pattern mask 132 that may be mounted on the mask stage 130 for imaging on the top-side of the substrate, which may be mounted on the substrate stage 140. The pattern mask 132 includes pattern alignment marks that correspond with substrate alignment marks on the back-side of the substrate. In the example described with reference to FIG. 1, the pattern mask 132 includes two pattern alignment marks corresponding to two substrate alignment marks on the back-side of the substrate. The pattern mask alignment marks may have the same image, or pattern, as the substrate back-side alignment marks. In example implementations, the pattern mask alignment marks may be of one mask pattern and the substrate back-side alignment mark may have a different pattern.

The top-side alignment camera system 120 includes a top-side system of optics 122 including mirrors, lenses, and/or prisms to direct light energy to a top-side charge-coupled device (“CCD”) camera 124. The top-side alignment camera system 120 may be used to align the pattern mask 132 to the top-side of the substrate when processing a substrate that may not use back side alignment.

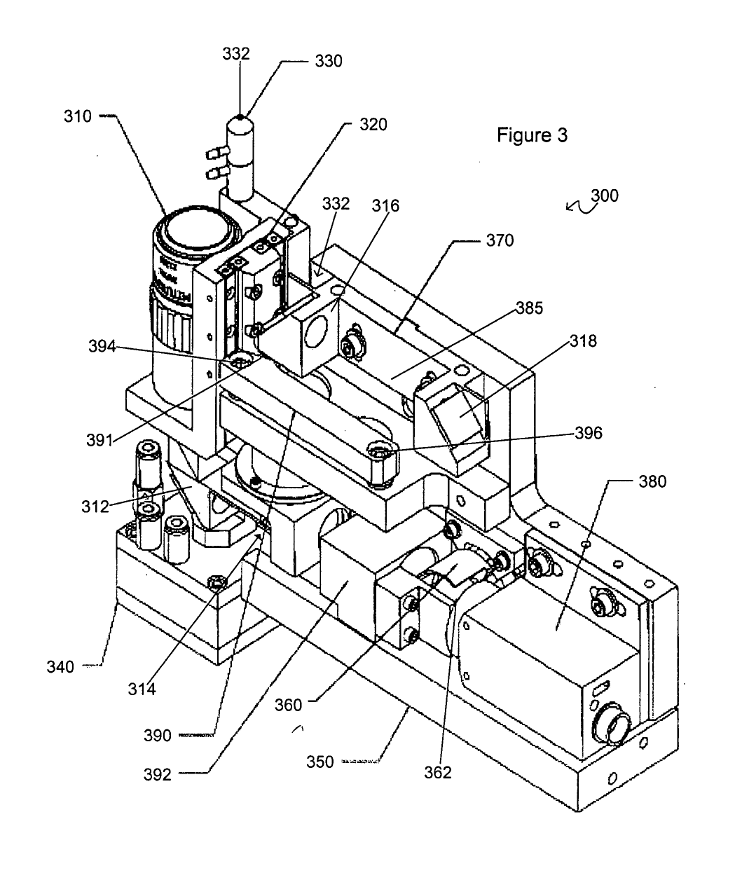

The pattern mask 132 may be mounted on the mask stage 130, which may be a part of a substrate and mask stage system 145 that includes the substrate stage 140. The substrate and mask stage system 145 keeps the substrate stage 140 fixed in relation to the mask stage 130 at all times except during alignment of the back-side alignment marks with a substrate mounted on the substrate stage 140. The substrate stage 140 is mobile relative to the mask stage 130 to enable alignment of the top-side pattern in the mask mounted on the mask stage 130 with the substrate alignment marks on the substrate mounted in the substrate stage 140. The substrate and mask stage system 145 includes a substrate stage controller 141 to enable positioning and locking of the location of the substrate stage 140 relative to the mask stage 130. The substrate stage controller 141 may include x-y motors, an air bearing and vacuum-locking components such as components described below with reference to FIGS. 3-5. The substrate and mask stage system 145 also includes components to enable positioning and locking of the location of the substrate and mask stage system 145, so that the mask stage 130 and substrate stage 140 are moved as a unit once the alignment process is complete.

The UV exposure projection lens 150 includes optical elements such as lenses and mirrors in configurations suitable to project images from the pattern mask 132 mounted on the mask stage 130 onto an object image plane 148. The UV exposure projection lens 150 may be maintained fixed in alignment with the UV exposure illuminator 110, which is also maintained fixed and stationary.

The first back-side dual magnification alignment camera system 160 and the second back-side dual magnification alignment camera system 170 are positioned below the substrate stage 140 to permit capture of images in the vicinity of the substrate stage. The first back-side dual magnification alignment camera system 160 and the second back-side dual magnification alignment camera system 170 are movable in an x-y plane, but remain fixed along a z-axis. Each of the first and second back-side alignment camera systems include a CCD camera operable to capture digital image data that may be processed using a pattern recognition system. The CCD cameras in the first and second back-side alignment camera systems 160, 170 may operate with the pattern recognition system to provide machine vision capabilities in processing images captured during alignment processes.

During alignment, the first and second back-side alignment camera systems 160, 170 capture first and second mask alignment marks on the pattern mask. To capture the image of the first mask alignment mark, the first back-side dual magnification alignment camera system 160 may be positioned generally at an area that includes an approximate location of a first pattern alignment mark. Similarly, when the first mask alignment mark image has been captured, the second back-side alignment camera system 170 may be positioned generally at an area that includes an approximate location of a second mask alignment mark. The approximate locations of the first and second mask alignment marks may be determined from historical data associated with a particular pattern mask and/or substrate.

The first back-side dual magnification alignment camera system 160 includes a dual optical path 162 that provides a low magnification and a high magnification optics setting. The dual optical path 162 is selectable; that is, a magnification shutter 164 may be triggered to select either the low or high magnification setting.

The second back-side dual magnification alignment camera system 170 may include a structure similar to the first back-side dual magnification alignment camera system 160. That is, the second back-side dual magnification alignment camera system 170 may include a second magnification shutter 174 and a dual optical path 172 that provides a low magnification setting and a high magnification setting.

Examples of the first back-side dual magnification alignment camera system 160 and the second back-side dual magnification alignment camera system 170 also include a lock down system for fixing the position of the camera systems 160, 170 once the pattern alignment mark locations are identified. In one example, the first and second back-side dual magnification alignment camera systems 160, 170 are moved while the camera systems 160, 170 “float” using air bearings that are turned off to lock down the camera systems 160, 170. Those of ordinary skill in the art will appreciate that any system of fixing the location of the camera systems 160, 170 may be used as well.

The controller 190 in FIG. 1 is depicted as a computer workstation. However, the controller 190 may be implemented in any suitable form. The controller 190 includes a processor, memory, and software programmed to perform examples systems and methods for providing back-side alignment of a top-side pattern. The controller 190 may also include hardware and software for performing substrate exposure functions. Functions may be incorporated in a single control system, or distributed among a variety of controllers. The controller 190, or another computer system, may include pattern recognition software, memory for storing image data and software for image analysis.

The controller 190 interfaces with the projection lithographic system 100 via the electrical/optical/mechanical hardware interface 192. The electrical/optical/mechanical hardware interface 192 includes drivers, relays, electronic circuits, pneumatic components and other hardware to interface with the hardware components in the projection lithographic system 100. For example, the electrical/optical/mechanical interface 192 may include a driver for controlling the CCD cameras in the top-side and back-side alignment camera systems 120, 160, 170; or drivers to control the state of the UV exposure illuminator 110; or motor drivers for controlling the X-Y motor drives for moving the back-side alignment camera systems 160, 170 as well as the substrate stage 140. Those of ordinary skill in the art will appreciate that the electrical/optical/mechanical interface 192 may be implemented in any suitable form. For example, the variety of functions performed in the electrical/optical/mechanical interface 192 may be distributed over a wide variety of modules accessible to the controller 190 and system 100.

In the example projection lithographic system 100 in FIG. 1, systems and methods for providing back-side alignment of the top surface substrate mask may be implemented prior to exposing the top surface pattern on the substrate. The substrate and mask stage system 145 keeps the mask stage 130 and substrate stage 140 movable as a unit during exposure of the substrate. During alignment, the first and second back-side alignment camera systems 160, 170 are used to define a location of the pattern alignment marks to use as a reference for motion of the substrate and mask stage system. When the first and second back-side alignment camera systems have identified this reference location, the substrate stage is moved (with the back-side alignment cameras as a reference) to align the substrate alignment marks with the pattern alignment marks. When the alignment marks are aligned, the substrate stage is locked to the substrate and mask stage system 145 to move the system 145 as a unit based on the pattern alignment marks as a reference during exposure of the substrate.

### 2. Example of Methods for Aligning a Pattern on the Top Side of a Substrate with a Pattern on the Back Side of the Subsrtate

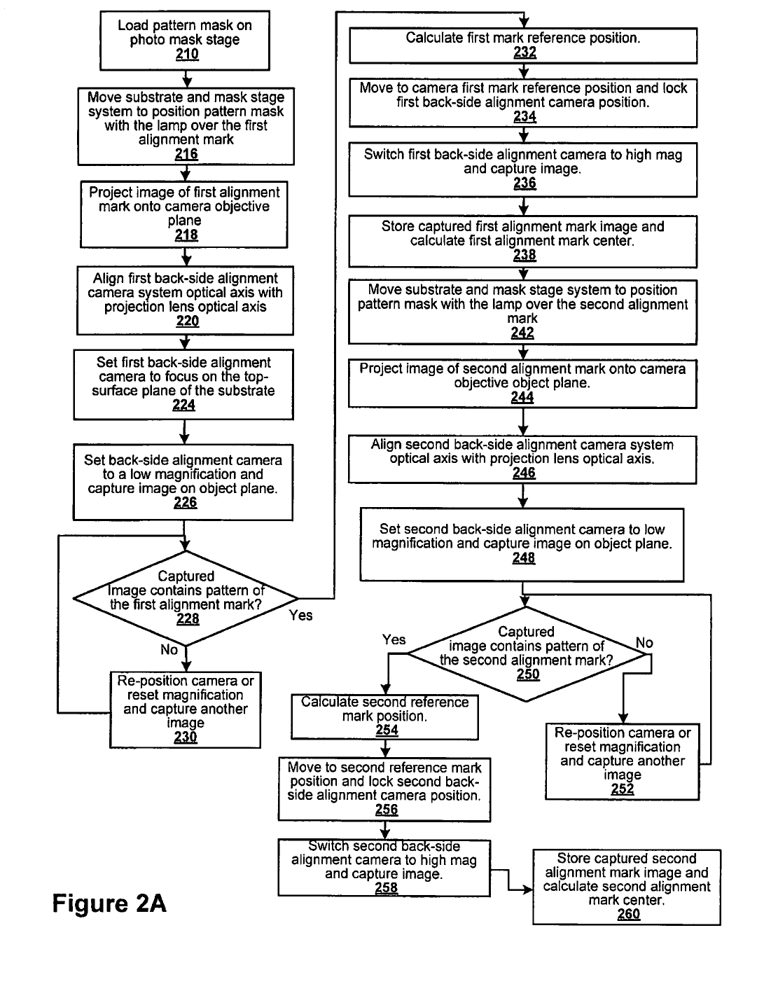

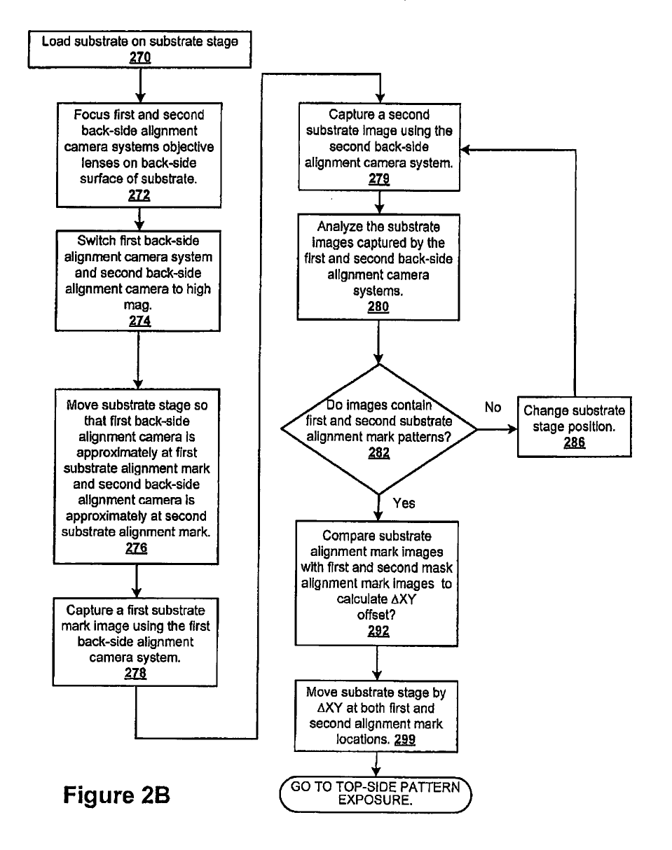

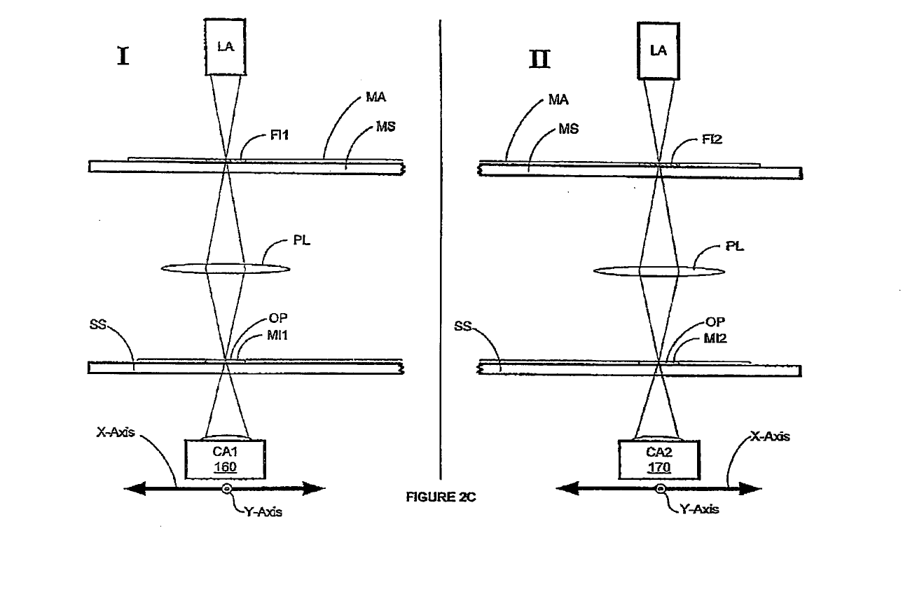

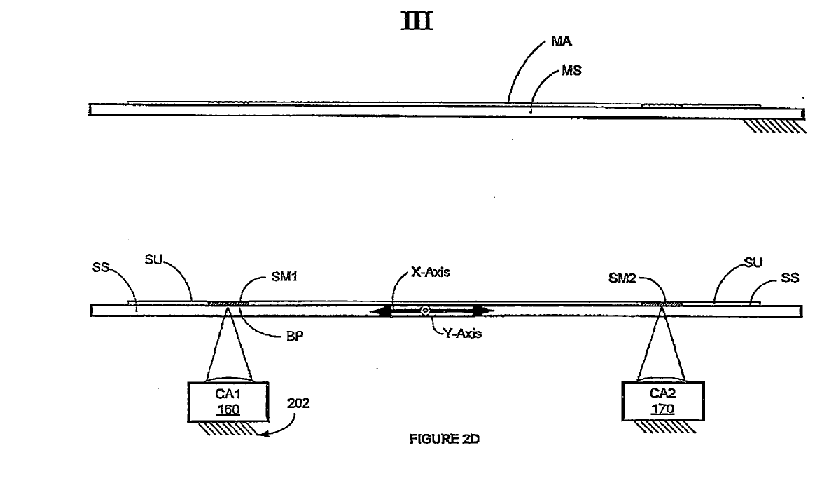

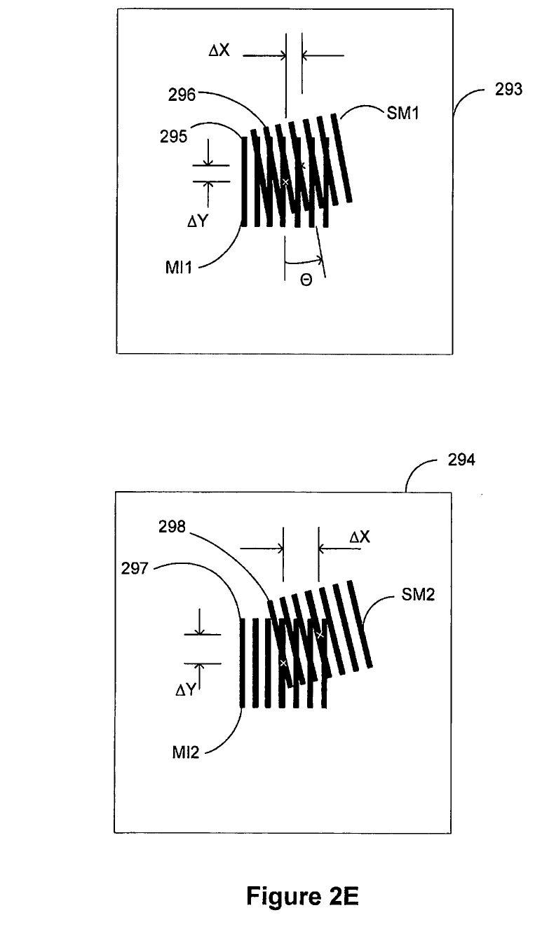

FIGS. 2A and 2B are flowcharts depicting an example of a method for providing alignment of a top-side pattern mask to a back-side surface of a substrate that may be implemented in the projection lithographic system 100 of FIG. 1. FIG. 2A illustrates a method 200 of detecting and identifying locations of alignment marks on the pattern mask for the top-side surface of the substrate from the back-side of the substrate. FIG. 2B illustrates a method 264 of searching for aligning the pattern mask with the substrate back-side based on the pattern mask alignment mark locations.

FIG. 2C is a schematic diagram illustrating operation of the projection lithographic system during the steps in the flowchart in FIG. 2A. FIG. 2C shows a portion of an example of the system of FIG. 1. FIG. 2C depicts operation of example systems and methods for providing alignment in two of three views (I, II, and III) of the system. View III is shown in FIG. 2D. View I shows a portion of the mask MA, mask stage MS and substrate stage SS above the first back-side alignment camera CA1. View II shows a portion of the mask MA, mask stage MS and substrate stage SS above the second back-side alignment camera CA2.

In view I, the substrate and mask stage system 145 is moved to a location that places the UV lamp LA over a pattern mask MA that is mounted on the mask stage MA such that the lamp LA is directly over a first mask alignment mark FI1. A projection lens PL is positioned under the mask stage MS aligned with the lamp LA to receive light energy from the lamp LA and to project a first mask alignment mark image MI1 on an object plane OP. The object plane OP is in the same plane as the top-surface of the substrate, except that in view I, the substrate is not yet mounted on the substrate stage SS. A dotted outlined box shows where the substrate is to be mounted on the substrate stage SS in view I. The first back-side alignment camera system CA1 is positioned under the substrate stage SU to capture the first mask alignment mark image MI1. The first back-side alignment camera system CA1 is controlled to move in an X-Y plane fixed in a location on the z-axis.

In view II, the substrate and mask stage system 145 is moved so that the lamp LA is positioned over a second mask alignment mark FI2 to permit a capture of a second mask alignment mark image MI2 by the second back-side alignment camera system CA2. The projection lens PL is aligned with the lamp LA to receive light energy from the lamp LA and to project the second mask alignment mark image MI2 on the object plane OP. As described above with reference to view I, the object plane OP is in the same plane as the top-surface of the substrate. The second back-side alignment camera system CA2 is positioned under the substrate stage SS. The second back-side alignment camera system CA2 is controlled to move in an X-Y plane fixed in a location on the z-axis.

FIG. 2D is a schematic diagram illustrating operation of the projection lithographic system during the steps taken in the flowchart in FIG. 2B. FIG. 2D depicts operation of example systems and methods for providing alignment using in view III of the three views (I, II, and III) of the system. View III schematically depicts the mask MA, the mask stage MS, and the substrate stage SS as entire components and both back-side alignment camera systems CA1 and CA2. View III also shows the substrate SU mounted on the substrate stage SS.

In view III, the first back-side alignment camera system CA1 is controlled to focus on the bottom surface of the substrate SU, which is shown mounted on the substrate stage SS. The first back-side alignment camera system CA1 is also maintained immobile (as shown at 202) at the first mask alignment mark location found during the method 200 described above with reference to FIG. 2A and view I in FIG. 2C. The substrate SU includes substrate marks SM1 and SM2 on the back-side surface of the substrate. The substrate stage SS is controlled to move in an X-Y plane (at fixed z-plane) to permit alignment of the first substrate mark SM1 with the first mask alignment mark FI1. The substrate stage SS may be moved to an initial position where the first back-side alignment camera system CA1 may image the back-side surface of the substrate to capture the image of the first substrate mark SM1.

View III also depicts the second back-side alignment camera system CA2 focusing on the bottom surface of the substrate SU. The second back-side alignment camera system CA2 is also maintained fixed in the X-Y plane at the second mask alignment mark location found during the method 200 described below with reference to FIG. 2A and view II in FIG. 2C. View III also shows the substrate SU mounted on the substrate stage SS. The substrate stage SS may be controlled to move in an X-Y plane (at fixed z-plane) to permit alignment of the second substrate mark SM2 with the second mask alignment mark FI2. The substrate stage SS may be moved to an initial position where the second back-side alignment camera system CA2 may image the back-side surface of the substrate to capture the image of the second substrate mark SM2.

In the description that follows below of method 200 in FIG. 2A, references to structural elements shall be with reference to FIG. 2C unless otherwise indicated. The substrate stage SS remains clear of the substrate and does not move for the method 200 in FIG. 2A. In the description that follows below of method 264 in FIG. 2B, references to structural elements shall be with reference to FIG. 2D unless otherwise indicated.

The method 200 in FIG. 2A begins at step 210 in which the pattern mask MA is mounted onto the pattern mask stage MS. Next, the substrate stage SS is checked to ensure that it is clear of any substrate at decision block 212. If the previously processed substrate is still on the substrate stage SS, the method 200 does not continue until the substrate is removed at step 214. Once the substrate stage SS is clear, the substrate and mask stage system is moved to a first imaging position in which the first mask alignment mark FI1 is substantially aligned with the lamp LA and the projection lens PL at step 216. At step 218, the lamp LA generates UV light to project the first mask alignment mark image MI1 onto the camera objective object plane OP.

At step 220, the first back-side alignment camera CA1 is moved to an approximate location of the target pattern of the first alignment mark FI1. The approximate location may be estimated from historical data acquired from performing previous alignment operations on similar substrates and masks. The approximate location may also be set by user input, or from data read from configuration data associated with the pattern mask and substrate.

At step 224, the objective lens of the first backside alignment camera CA1 is set to focus on the top surface plane of the substrate at the object plane OP, which is where the top surface plane of the substrate will be when the substrate is loaded on the substrate stage SS. At step 226, the magnification of the first backside alignment camera CA1 may be set to a coarse setting (low magnification). In some cases, example pattern masks may include alignment marks that may be imaged in high magnification. The CCD camera in the first backside alignment camera system CA1 captures an image at the object plane OP for analysis by a pattern recognition function in software.

At decision block 228, the captured image may be analyzed to verify the captured image. For example, pattern recognition software may analyze the captured image to determine if a sufficient portion of the first alignment mark image MI1 was captured. The image may also be compared to a user defined image, or other image data indicative of an expected pattern for the image to verify that the captured image matches an expected image. If the captured image is determined to not contain the pattern expected, the first backside alignment camera system CA1 may be positioned, or the magnification may be adjusted to high magnification for another image capture at step 230. If the captured image is determined at decision block 228 to contain the first alignment mark pattern, or at least enough of the pattern, a first mark reference position may be calculated to correspond with the position of the first back-side alignment camera system CA1 that places the first mask alignment mark image MI1 in the center of the field of view of the camera objective at step 232. The first back-side alignment camera system CA1 is then moved at step 234 to the first mark reference position and locked in position to remain stationary for the remainder of the alignment procedure. At step 236, the first back-side alignment camera system CA1 is switched to high magnification, and the first alignment mark is imaged in high magnification. At step 238, the captured image of the first back-side alignment mark is then stored and a first alignment mark center position is calculated.

At step 242, the substrate and mask stage is moved to position a second imaging position in which the second mask alignment mark FI2 is substantially aligned with the lamp LA and the projection lens PL. The UV energy from the lamp LA projects an image of the second alignment mark on to the camera objective plane at step 244. At step 246, the second back-side alignment camera CA2 is moved to a location that at least approximately aligns the optical axis of the CCD camera with the optical axis of the projection lens PL. The magnification of the second back-side alignment camera system CA2 is set to a low magnification setting at step 248, although a high magnification setting may also be used. The image on the object plane is then captured in the CCD camera of the second back-side alignment camera system CA2.

At decision block 250, the captured image is analyzed to determine if it contains a pattern expected for the second mask alignment mark FI2. The pattern is not contained in the image, the camera may be re-positioned, and/or the image may be captured at a different magnification setting at step 252. If the second mask alignment mark FI2 pattern is contained in the captured image, a second mark reference position may be calculated at step 254 to correspond with the position that places the captured image of the second mask alignment mark image MI2 in the center of the field of view of the camera objective. The second back-side alignment camera system CA2 is then moved at step 256 to the second mark reference position and locked in position to remain stationary for the remainder of the alignment procedure. The second back-side alignment camera system CA2 is then switched to high magnification and a high magnification image of the second alignment mark is captured at step 258. The captured image of the second alignment mark is then stored and the second alignment mark center position of the mark image is calculated at step 260.

Once the first and second alignment mark images have been captured, the system may align the images with the substrate alignment marks SM1 and SM2. In the method illustrated by the flowchart in FIG. 2B, a substrate SU is loaded on to the substrate stage SS at step 270. At step 272, the objective lenses of the first and second back-side camera alignment systems CA1, CA2 are focused on the back-side surface BP of the substrate SU. The first and second back-side camera alignment systems CA1, CA2 are set to a high magnification at step 274. At step 276, the substrate stage SU (but not the mask stage) is moved to position the first and second substrate alignment marks SM1 and SM2 at locations that are approximately aligned with the optical axes of the first and second back-side alignment camera systems CA1 and CA2 respectively. The approximate locations of the substrate alignment marks may be determined from historical data acquired from performing previous alignment operations on similar substrates and masks. The approximate locations may also be set by user input, or from data read from configuration data associated with the pattern mask and substrate.

At step 278, an image of the substrate back-side is captured by the first back-side alignment camera system CA1. At step 279, a second substrate image is captured by the second back-side alignment camera system CA2. At step 280, the captured images are analyzed using pattern recognition software. At decision block 282, the captured images checked to determine if they contain the patterns of the alignment marks on the back-side surface of the substrate SU. At step 286, if only one of the captured images includes the expected pattern, the process of capturing the images may be repeated for both substrate alignment marks, or for only one substrate alignment mark. If both captured images contain the respective patterns, the first and second substrate alignment mark images SM1 and SM2 are compared with the previously-stored first and second mask alignment mark images at step 292. The comparison is performed to calculate a ΔXY offset between the images.

The ΔXY offset may be calculated using image data collected by imaging the mask alignment marks FI1, FI2 and the substrate alignment marks SM1, SM2. FIG. 2E illustrates examples for determining a ΔXY offset. FIG. 2E shows a first captured image field of view 293 and a second captured image field of view 294. The first captured image field of view 293 includes a first mask alignment mark image MI1 centered in the first captured image field of view 293. This is the result of having performed a search for the first mask alignment mark image MI1 prior to loading the substrate and moving the first back-side alignment camera system CA1 to the location that puts the first mask alignment mark image MI1 in the center of the field of view. The first captured image field of view 293 also shows a first substrate alignment mark image SM1 as the image may appear when the first back-side alignment camera system CA1 images the substrate alignment mark image SM1 after loading the substrate onto the substrate stage SS.

The second captured image field of view 294 includes a second mask alignment mark image MI2 centered in the second captured image field of view 294. This is the result of having performed a search for the second mask alignment mark image MI2 prior to loading the substrate and moving the second back-side alignment camera system CA2 to the location that puts the second mask alignment mark image MI2 in the center of the field of view (see steps 254 and 256 in FIG. 2A). The second captured image field of view 294 also shows a second substrate alignment mark image SM2 as the image may appear when the second back-side alignment camera system CA1 images the substrate alignment mark image SM2 after loading the substrate onto the substrate stage SS.

A ΔXY offset may be determined to position the substrate stage SU such that the first mask alignment mark image MI1 is aligned with the first substrate alignment mark image SM1. If the first mask alignment mark image MI1 and the first substrate alignment mark SM1 have the same pattern, or image, the mark images may overlap with each other when the marks are aligned. In some examples, the patterns of the marks may not be identical and the ΔXY offset may be determined to be an offset between points on each mark (e.g. centers of the marks). The first mask alignment mark MI1 in the first captured image field of view 293 is shown with its center marked by an ‘X.’ The first substrate alignment mark SM1 is also shown with its center marked by an ‘X.’ In the example shown in FIG. 2E, the ΔXY offset may be determined as an offset along the x-axis (ΔX) and an offset along the y-axis (ΔY) between the centers of the images MI1 and SM1. Similarly, for the second captured image field of view 294, the second mask alignment mark image MI2 in the second captured image field of view 294 is shown with its center marked by an ‘X.’ The second substrate alignment mark image SM2 is also shown with its center marked by an ‘X.’ The ΔXY offset may be determined as an offset along the x-axis (ΔX) and an offset along the y-axis (ΔY) between the centers of the images MI2 and SM2. The example in FIG. 2E describes calculating the ΔXY offsets at two different alignment mark locations using two different back-side alignment camera systems CA1 and CA2. This permits correction along an angle of rotation (theta) as well as along the X and Y axes. In addition, the captured images may be compared in further detail to verify overlap of the images or to increase accuracy with averaging.

Referring back to FIG. 2A, at step 299, the substrate stage SS is moved by the ΔXY offset to position the first and second back-side alignment camera systems CA1, CA2 (which are not moved) to align the substrate alignment marks with the mask alignment marks. In processes such as the substrate exposure process, the substrate and mask stage system may now be moved as a unit with the top-side pattern aligned with the back-side surface of the substrate. Once the substrate is aligned to the pattern mask, the top-side pattern may be exposed onto the top-side of the substrate.

Those of ordinary skill in the art will appreciate that the methods described above with reference to FIGS. 2A-2D are example methods, and that other alternative methods may be implemented to provide alignment of a top-side pattern mask to a back-side surface of a substrate.

### 3. Example of a Back-side Alignment Camera System

FIG. 3 is an example of a back side alignment camera assembly 300 that may be used in the system shown in FIG. 1. The back side alignment camera assembly 300 includes an objective lens 310, a camera focus slide 320, a focus air gauge probe 330, a focus air cylinder 340, a vacuum air bearing 350, a high-low magnification switching shutter 360, a high magnification path length focus adjustment slide 370, a CCD camera 380, an adjustment arm 390, and a low magnification optics assembly 392. The back-side alignment camera assembly 300 includes a dual optical path to select between two magnifications and an auto-focus component to automatically focus on a desired object plane.

The camera system objective lens 310 receives an image into the optical path leading to the CCD camera 380. The optical path is a dual-path: a high magnification path and a low magnification path. The optical path proceeds through the camera system objective lens 310 to a first mirror 312, which changes the direction of the optical path. The optical path proceeds into the body of the camera assembly 300 towards a first prism 314. The first prism 314 splits the optical path into the low magnification path towards the low magnification optics assembly 392, and the high magnification path towards first high magnification mirror 316. At the first high magnification mirror 316, the optical path is re-directed so that it is parallel with the low magnification path to a second high magnification mirror 318. The distance between the first and second high magnification mirrors 316 and 318 may be adjusted by the high magnification path length focus adjustment slide 370. The second high magnification mirror 318 re-directs the optical path towards a receiving prism 362. The low magnification path proceeds through the low magnification optics assembly 392 also towards the receiving prism 362. The receiving prism 362 is configured to integrate the low magnification and high magnification optical paths into a single optical path leading to the CCD camera 380. However, the high-low magnification switching shutter 360 may be triggered to select between either the high magnification optics path and the low magnification optics path.

The high-low magnification switching shutter 360 is a flat component shaped in an arc mounted over a receiving prism 362 and coupled to a motor via a mechanical linkage (such as for example, a cam). The motor may be coupled to a control system (such as controller 190 in FIG. 1) to receive signals to control the shutter to move high-low magnification switching shutter 360 between a high magnification and a low magnification position. As described above, the receiving prism 362 is positioned to receive an image from both the high magnification optics path and the low magnification optics path. When the high-low magnification switching shutter 360 is switched to allow passage of one of the low or high magnification optical paths and to block the other, the high-low magnification switching shutter 360 rotates to block the image of the path that is not selected. The selected path allows the image to reach the receiving prism 362 and to continue to the CCD camera 380.

The camera system objective lens 310 may be configured to focus on images on the level of both surfaces of the substrate in the substrate stage. A projection lithographic system such as the system 100 shown in FIG. 1 may be used to process substrates of different thickness. A suitable camera system objective lens 310 may be selected and configured to focus on an object plane at any desired level. The auto-focus capability of the back-side alignment camera assembly 300 provides the ability to focus on the required object plane regardless of the thickness of the substrate.

The camera system objective lens 310 may be focused by moving the lens along an axis perpendicular to the desired object plane. In the camera assembly 300 in FIG. 3, the camera system objective lens 310 may be moved along the camera focus slide 320. The camera system objective lens 310 may be moved using the air cylinder 340. A downward slide stop 322 is mounted in the camera focus slide 320 to stop the camera movement in the downward direction.

The focus air gauge probe 330 may be used to provide the auto-focusing feature in the camera assembly 300. The focus air gauge probe 330 is connected to receive air from the air cylinder 340. The air escapes through a probe tip 332 on the focus air gauge probe 330 towards the substrate on the substrate stage. The focus air cylinder 340 also provides the air that pushes the camera system objective lens 310 up towards the substrate. The focus air cylinder 340 generates air through at least two paths, one of which is the focus air gauge probe 330. As the focus air gauge probe 330 approaches the substrate, the air supplied to the probe tip 332 is diverted to the other side of the air cylinder 340 and the focus air gauge probe 330 (as well as the camera system objective lens 310) stops.

If no substrate is on the substrate stage, the focus air gauge probe 330 does not operate to stop the camera system objective lens 310 because the substrate is not present to divert the air supplied to the probe tip 332. A hard stop, or physical obstruction may be placed in the path of the structure supporting the objective lens 310 to stop the objective lens 310. In one example of the camera assembly 300, the hard stop may be placed at a location which allows the objective lens 310 to focus on a plane at the level of the top surface of the substrate. Substrates of various thicknesses may be used in an exposure system such as the projection lithographic system 300 shown in FIG. 1. The hard stop may be set to focus the objective lens 310 on the top surface of any substrate placed in the substrate stage. By using the focus air gauge probe 330, substrates of different thickness may be mounted on the substrate stage without requiring any further adjustment. When focusing on the back-side surface of the substrate, the focus air gauge probe 330 stops the objective lens 310 at the correct level automatically regardless of the thickness of the substrate.

In the example shown in FIG. 3, the objective focus slide access adjustment arm 390 may be adjusted to adjust the objective lens 310 travel normal to the optical exposure plane. Adjustment of the adjustment arm 390 may be accomplished using adjustment screws 394 and 396.

The back-side alignment camera assembly 300 may be mounted on the vacuum air bearing 350 for system movement and position locking. The vacuum air bearing 350 includes a source of air for moving the assembly and a vacuum that locks the assembly in a fixed location. The source of air allows the assembly 300 to “float” above a surface while a back-side alignment camera system alignment system moves the assembly 300 within an X-Y plane at a fixed vertical level (z-axis). Once the camera assembly 300 is positioned at a desired location, the camera assembly 300 location may be locked down, or fixed, at that location by turning the source of air off and leaving the vacuum on. This sets the camera assembly 300 down on the surface with a suction to keep it immobile. The camera assembly 300 may also be constructed to have enough weight to stay frictionally fixed at the location as the alignment and exposure processes are performed.

The single CCD camera 380 in the back-side alignment camera assembly 300 may be used to receive either of the low or high magnification optical paths. The CCD camera 380 may be coupled to a control system (such as controller 190 in FIG. 1) to communicate image data collected during optical scans for storage in memory and for processing by software (such as pattern recognition software).

### 4. Example of a Back-side alignment Camera X-Y Alignment Stage

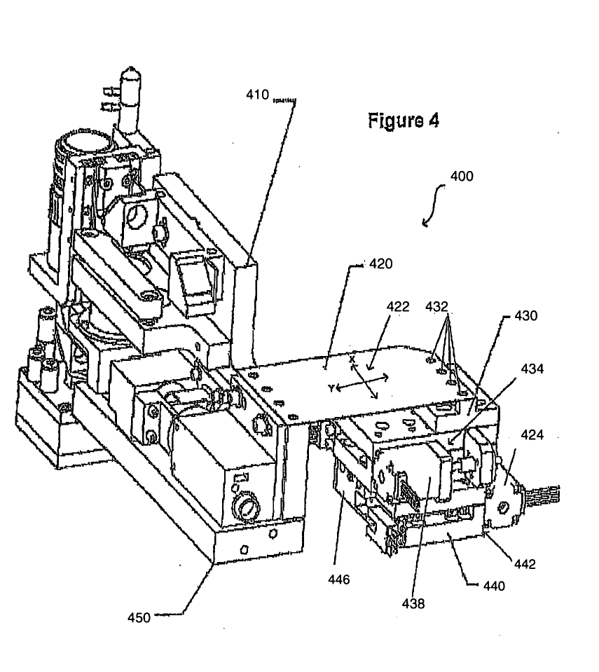

The back-side alignment camera assembly 300 may be moved in an X-Y plane at a fixed z-axis. FIG. 4 is a schematic diagram of a back-side camera X-Y alignment stages assembly 400 that may be used in the example shown in FIG. 1 to control the movement of a backside camera system 410 in the X-Y plane. The backside camera alignment stages assembly 400 includes a flexure 420, a camera Y-axis slide stage 430, a camera X-axis slide stage 440, and a camera vacuum air bearing 450. The back-side camera system 410 may be the same as or similar to the back-side alignment camera assembly 300 in FIG. 3.

The back-side camera system 410 is coupled to the back-side camera X-Y alignment stages assembly 400 via the flexure 420. The flexure 420 is a mechanical link that transfers forces that move the back-side camera system 410 in the X and Y directions (shown at 422). The flexure 420 may be any flat component having sufficient rigidity to accurately move the back-side camera system 410. The flexure 420 also has some flexibility, which allows the back-side camera system 410 to move more efficiently using air bearings such as the camera vacuum air bearing 450. The flexibility of the flexure 420 provides a give to permit the back-side camera system 410 to press down sufficiently to remain in a fixed location. In an example of the back-side camera system 410 in FIG. 4, the camera vacuum air bearing 450 includes a vacuum to further lock down the back-side camera system 410 when it has reached a desired position. The air bearing is activated to allow the back-side camera system 410 to move and the vacuum is activated to fix the position of the back-side camera system 410.

The flexure 420 may be fixed to the camera Y-axis slide stage 430 at 432. The camera Y-axis slide stage 430 may be controlled by a linear actuator 434. The camera Y-axis slide stage 430 may be cross mounted on the camera X-axis slide stage 440. The camera Y-axis slide stage 430 includes a fixed Y stage component 436 having the motor portion of the linear actuator 434 fixed to the camera X-axis slide stage 440. The movable portion of the linear actuator 434 is coupled to the camera Y-axis slide stage 430, which moves when the motor portion of the linear actuator 434 is activated. Similarly, the camera X-axis slide stage 440 includes a fixed X-stage component 442 on which a motor portion of a linear actuator 442 is fixed. The movable portion of the linear actuator is coupled to a slidable portion 446, which is fixed to the camera Y-axis slide stage 430.

### 5. Example of Substrate Stage X-Y, Theta Alignment Structure

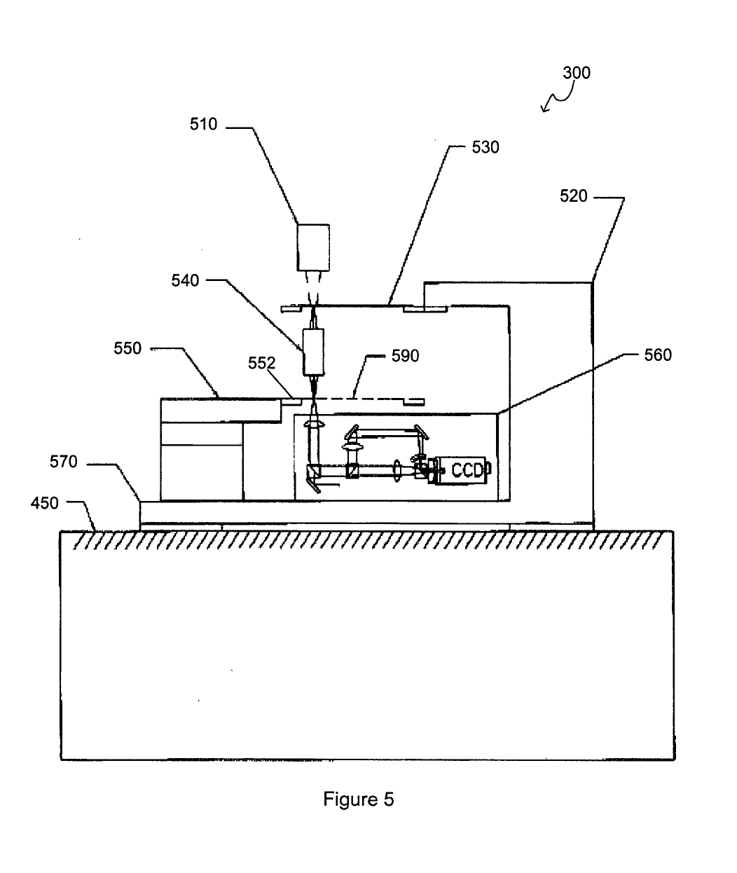

FIG. 5 is an example of a projection lithographic system 500 for providing alignment further illustrating an example of structure for performing backside substrate X-Y, theta alignment. The projection lithographic system 500 in FIG. 5 includes a UV exposure illuminator 510, a mask and substrate support structure 520, a projection lens 540, a substrate X-Y, theta stage assembly 550, a back-side camera system 560, a carriage support structure 570, and a machine base 580. The system 500 in FIG. 5 shows a mask 530 mounted on a mask stage 522 and a substrate image 590 to illustrate where the substrate may be mounted on a substrate stage 552. The mask 530 includes alignment marks that overlay substrate backside alignment marks.

The mask and substrate support structure 520 is used to scan the mask and substrate after alignment, which is when the mask 530 and substrate are maintained in a fixed location relative to each other. The mask and substrate support structure 520 may be provided with weight sufficient to maintain the system 500 stable during operation and while the various parts of the system 500 are moved.

The projection lens 540 and the UV exposure illuminator 510 are rigidly mounted relative to the machine base 580 and may be presumed aligned with each other and stationary during alignment and exposure processes.

The substrate X-Y, theta stage assembly 550 is mounted on the mask and substrate support structure 520 and includes components to move the substrate stage 552 in the X-Y plane and in a theta angle. The substrate stage 552 is moved to position the substrate to place the bottom side alignment marks in alignment with the stored locations of the projected mask alignment marks as described above with reference to FIGS. 1 to 2D.

The back-side alignment camera system 560 is positioned below the substrate image 590 and aligned with the projection lens 540 during an alignment procedure. This allows the camera system 560 to capture the image of the mask alignment marks. In an example of the projection lithographic system 500, a second back-side alignment camera system may be added.

The carriage support structure 570 supports the back-side camera system 560 and the substrate and mask support structures 550. The carriage support structure 570 is mounted on the machine base 580, which may be a granite support block having sufficient weight to keep the system 500 stable.

One of ordinary skill in the art will appreciate that the methods and systems described herein may be implemented using one or more processors having memory resources available for storing program code and data. One skilled in the art will also appreciate that all or part of systems and methods consistent with the present invention may be stored on or read from other machine-readable media, for example, secondary storage devices such as hard disks, floppy disks, and CD-ROMs; a signal received from a network; or other forms of ROM or RAM either currently known or later developed.

The foregoing description of implementations has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed:

1. A method for aligning a top-side pattern mask with a substrate back-side comprising:
capturing an image of a mask alignment mark in an image field of view using a movable back-side alignment camera system;
fixing the back-side alignment camera system to a reference position corresponding to the location of the image of the mask alignment mark in the image field of view;
capturing an image of a substrate alignment mark on the substrate back-side; and
positioning the substrate to align the image of the substrate alignment mark with the image of the mask alignment mark.

2. The method of claim 1 where the pattern mask includes two mask alignment marks further comprising:
capturing the image of the second mask alignment mark in a second image field of view using a second movable back-side alignment camera system;
fixing the second back-side alignment camera system location to a second reference position corresponding to the location of the image of the mask alignment mark in the second image field of view;
capturing an image of the second substrate alignment mark; and
positioning the substrate to align the image of the second substrate alignment mark with the second mask alignment mark.

3. The method of claim 1 where the step of fixing the back-side alignment camera system to the reference position of the mask alignment mark by determining a position of the back-side alignment camera system that centers the image of the mask alignment mark in the image field of view.

4. The method of claim 1 where the step of positioning the substrate stage comprises the step of determining a ΔX-Y offset between the captured back-side image and captured mask image, and moving the substrate by the ΔX-Y offset.

5. The method of claim 1 further comprising:
switching the back-side alignment camera system to a low magnification prior to the step of capturing the image of the mask alignment mark on the pattern mask or prior to the step of capturing the substrate back-side image.

6. The method of claim 1 further comprising:
switching the back-side alignment camera system to a high magnification prior to the step of capturing the image of the mask alignment mark on the pattern mask or prior to the step of capturing the substrate back-side image.

7. A method for aligning a pattern mask to a back-side of a substrate comprising:
supporting the pattern mask on a mask stage near a substrate stage for supporting a substrate substantially parallel with the pattern mask;
prior to mounting the substrate on the substrate stage, performing the steps of:
capturing an image of a mask alignment mark on the pattern mask using a back-side alignment camera system;
identifying a reference position of the mask alignment mark in an image field of view from the captured mask image; and
fixing the position of the back-side alignment camera system at the reference position;
mounting the substrate on to the substrate stage, the substrate having a substrate alignment mark on a substrate back-side, and performing the steps of:
capturing a substrate back-side image with the back-side alignment camera system;
comparing the captured back-side image and the captured mask image; and
positioning the substrate stage to align the captured back-side image and the captured mask image in the image field of view.

8. The method of claim 7 where the pattern mask includes two mask alignment marks further comprising:
performing the steps performed prior to mounting the substrate on the substrate stage a second time using a second back-side camera alignment system and performing the steps performed after mounting the substrate for the second substrate alignment mark.

9. The method of claim 7 where the step of identifying a reference position of the mask alignment mark by determining a position of the back-side alignment camera system that centers the image of the mask alignment mark in the image field of view.

10. The method of claim 7 where the step of positioning the substrate stage comprises the step of determining a ΔX-Y offset between the captured back-side image and captured mask image, and moving the substrate stage by the ΔX-Y offset.

11. The method of claim 7 further comprising:
moving the back-side alignment camera system using an air bearing and X-Y motor system.

12. The method of claim 7 further comprising:
moving the substrate stage using an air bearing and X-Y motor system.

13. The method of claim 7 further comprising:
switching the back-side alignment camera system to a low magnification prior to the step of capturing the image of the mask alignment mark on the pattern mask or prior to the step of capturing the substrate back-side image.

14. The method of claim 7 further comprising:
switching the back-side alignment camera system to a high magnification prior to the step of capturing the image of the mask alignment mark on the pattern mask or prior to the step of capturing the substrate back-side image.

15. A system for aligning a pattern mask to a substrate back-side comprising:
a mask stage for mounting a pattern mask having at least one mask alignment mark;
a substrate stage for mounting a substrate having at least one substrate alignment mark on the substrate back-side, the substrate stage positioned substantially parallel to the mask stage and movable along a plane parallel to the mask stage, the substrate stage and wafer stage being connected and movable as a unit; and
a back-side alignment camera system positioned beneath the substrate stage, the back-side alignment camera system having an objective lens aligned with an optical path to a camera, the back-side alignment camera system being movable along a plane parallel to the substrate stage and operable to capture an image of the mask alignment mark, where the image is analyzed to identify a reference position, the back-side alignment camera system being operable to lock in at the reference position to capture a substrate back-side image for aligning the substrate back-side image with the image of the mask alignment mark.

16. The system of claim 15 where the pattern mask includes a second mask alignment mark and the substrate includes a second back-side alignment mark, the system further comprising:
a second back-side alignment camera system positioned beneath the substrate stage, the second back-side alignment camera system being operable to capture a second mask image of the second mask alignment mark and to identify a second reference position of the second mask alignment mark, the second back-side alignment camera system being operable to lock in at the second reference position, and to capture a second substrate back-side image for aligning the second substrate back-side image with the image of the second mask alignment mark.

17. The system of claim 15 where the back-side alignment camera system further includes:
a charge-coupled device (“CCD”) camera operable to capture a digital representation of an image.

18. The system of claim 15 further comprising:
a pattern recognition system for analyzing the images captured by the back-side alignment camera system.

19. The system of claim 15 where the back-side alignment camera system further includes:
a first optical path and a second optical path having a higher magnification than the first optical path; and
a magnification shutter to select between the first and second optical paths.

20. The system of claim 15 further comprising:
an auto-focusing assembly comprising an air cylinder to generate an air flow through a focus air gauge probe and through a second air path, the auto-focusing assembly positioned such that the focus air gauge probe is fixedly connected to the objective lens and directed towards the substrate on the substrate stage to permit the substrate to obstruct the air flow out of the focus air gauge probe and force the air flow towards the second air path to stop the objective lens.

21. The system of claim 15 further comprising:
a light source; and
a projection lens to project the image of the mask alignment mark along an object plane for capture by the back-side alignment camera system, where the light source and projection lens operate in exposing the substrate with the pattern mask.

22. The system of claim 21 where the light source is a UV exposure illuminator.

23. A system for exposing a substrate comprising:
a light source for projecting light energy along a light source optical path;
a projection lens substantially optically aligned with the light source;
a mask stage between the light source and the projection lens substantially perpendicular to the light source optical path for mounting a pattern mask, the pattern mask having at least one mask alignment mark;
a substrate stage for mounting a substrate having at least one substrate alignment mark on the substrate back-side, the substrate stage positioned substantially parallel to the mask stage and movable along a plane parallel to the mask stage, the substrate stage and wafer stage being connected and movable as a unit; and
a back-side alignment camera assembly positioned beneath the substrate stage, the back-side alignment camera system having an objective lens aligned with an optical path to a camera; and
a back-side alignment system operable to move the back-side alignment camera assembly along a plane parallel to the substrate stage, to capture an image of the mask alignment mark and to identify a reference position, the back-side alignment system being operable to lock in the back-side alignment camera assembly in a position, and to capture an image of the substrate back-side to the image of the substrate back-side with the image of the mask alignment mark.

24. The system of claim 23 where the pattern mask includes a second mask alignment mark and the substrate includes a second back-side alignment mark, the system further comprising:
a second back-side alignment camera assembly positioned beneath the substrate stage, the second back-side alignment camera assembly being operable to capture a second mask image of the second mask alignment mark and to identify a second reference position, the back-side alignment camera system being operable to lock the second back-side alignment camera assembly in the second reference position, and to capture a second substrate image of the substrate back-side to align the image of the second substrate alignment mark with the image of the second mask alignment mark.

25. The system of claim 23 where the back-side alignment camera system further includes:
a charge-coupled device (“CCD”) camera operable to capture a digital representation of an image.

26. The system of claim 23 further comprising:
a pattern recognition system for analyzing the images captured by the back-side alignment camera system.

27. The system of claim 23 where the back-side alignment camera assembly further includes:
a first optical path and a second optical path having a higher magnification than the first optical path; and
a magnification shutter to select between the first and second optical paths.

28. The system of claim 23 further comprising:
an auto-focusing assembly comprising an air cylinder to generate an air flow through a focus air gauge probe and through a second air path, the auto-focusing assembly positioned such that the focus air gauge probe is fixedly connected to the objective lens and directed towards the substrate on the substrate stage to permit the substrate to obstruct the air flow out of the focus air gauge probe and force the air flow towards the second air path to stop the objective lens.

29. The system of claim 23 where the light source is a UV exposure illuminator.

30. A camera system for providing back-side alignment of a pattern mask and a substrate comprising:
an optics assembly including an objective lens for receiving an image along an optical path to a camera;
a camera vacuum air bearing to support the optics assembly and permit the optics assembly to move along an x-y plan when the air bearing is on and lock the optics assembly into position when the air bearing is turned off;
a link for connecting the optics assembly to an x-y stage, the x-y stage having an x-axis motor and a y-axis motor; and
an interface to a controller to control the camera system to perform a back-side alignment by imaging a pattern mask alignment mark, determining a reference position from the image of the pattern mask alignment mark, locking the camera system into the reference position, and capturing an image of a substrate alignment mark to align the image of the pattern mask alignment mark with the image of the substrate alignment mark.

31. The camera system of claim 30 where the optical path includes a high magnification path, a low magnification path, and a switch for selecting between the high magnification path and the low magnification path.

32. The camera system of claim 30 where the link is an x-y flexure.
